(19) United States
(12) Patent Application Publication
(10) Pub. No.: US 2019/0286118 A1
(43) Pub. Date: Sep. 19, 2019

(54) REMOTE VEHICLE CONTROL DEVICE AND REMOTE VEHICLE CONTROL METHOD

(71) Applicant: DENSO TEN Limited, Kobe-shi (JP)

(72) Inventors: Fumiaki BANDO, Kobe-shi (JP); Minoru MAEHATA, Kobe-shi (JP); Miki HITOTSUYA, Kobe-shi (JP)

(73) Assignee: DENSO TEN Limited, Kobe-shi (JP)

(21) Appl. No.: 16/227,377

(22) Filed: Dec. 20, 2018

(30) Foreign Application Priority Data
Mar. 15, 2018 (JP) 2018-048364

(51) Int. Cl. G05D 1/00; G07C 5/00; B62D 15/02; B60R 1/00

(52) U.S. Cl. CPC G05D 1/0016; G05D 1/0044; G05D 2201/0213; B62D 15/02; B60R 1/00; G07C 5/008

(57) ABSTRACT

A remote vehicle control device includes: a display unit; an operation unit configured for operating a vehicle; a signal generating unit configured to generate control signals for the vehicle on the basis of operations on the operation unit; and a communication unit configured to perform communication with the vehicle. The display unit displays synthetic images, each of which shows a surrounding area of the vehicle as seen from a virtual viewpoint, and includes the surrounding area of the remote vehicle control device, and is generated on the basis of plural images acquired by plural on-board cameras mounted on the vehicle, respectively, and the communication unit transmits the control signals to the vehicle.

### CROSS-REFERENCE TO RELATED APPLICATIONS

This application is based on and claims priority under 35 USC 119 from Japanese Patent Application No. 2018-48364 filed Mar. 15, 2018.

### BACKGROUND

### Technical Field

The present invention relates to a remote vehicle control device and a remote vehicle control method.

### Related Art

Recently, various technologies relates to remote vehicle control have been proposed. For example, a mobile terminal proposed in Patent Literature 1 is a terminal for moving a vehicle from a first position to a second position. This mobile terminal displays bird's eye view images including an image of the vehicle on the basis of images acquired by a camera installed in the terminal, and receives user's operations for the vehicle. Also, for example, a parking assistance device proposed in Patent Literature 2 makes it possible to park a vehicle using a remote control means such as a joystick. Also, for example, a remote vehicle control system proposed in Patent Literature 3 includes a mobile terminal, which transmits control signals corresponding to touch operations on a touch panel, to a vehicle. This mobile terminal can transmit travel control signals and steering control signals to the vehicle.

[Patent Literature 1] Japanese Patent Application Laid-Open No. 2014-65392

[Patent Literature 2] Japanese Patent Application Laid-Open No. 2010-95027

[Patent Literature 3] Japanese Patent Application Laid-Open No. 2016-74285

### SUMMARY

However, the technologies according to the related art have a problem that convenience and operability in remote vehicle control are not thoroughly satisfactory.

The present invention was made in view of the above-mentioned problem, and an object of the present invention is to provide a technology capable of improving convenience and operability in remote vehicle control.

According to an aspect of the present disclosure, there is provided a remote vehicle control device including: a display unit; an operation unit configured for operating a vehicle; a signal generating unit configured to generate control signals for the vehicle on the basis of operations on the operation unit; and a communication unit configured to perform communication with the vehicle. The display unit displays synthetic images, each of which shows a surrounding area of the vehicle as seen from a virtual viewpoint, and includes the surrounding area of the remote vehicle control device, and is generated on the basis of plural images acquired by plural on-board cameras mounted on the vehicle, respectively, and the communication unit transmits the control signals to the vehicle.

In the remote vehicle control device, the communication unit may receive the synthetic images generated in the vehicle, from the vehicle.

In the remote vehicle control device, the control signals may include signals related to control on viewpoint positions and sight line directions of the synthetic images.

In the remote vehicle control device, the display unit may display a location of the remote vehicle control device on the synthetic images.

In the remote vehicle control device, when approach of any other object to the vehicle or the remote vehicle control device is detected, the display unit may display expanded synthetic images showing the surrounding area of the object approaching the vehicle or the remote vehicle control device.

In the remote vehicle control device, approach of the object to the vehicle or the remote vehicle control device may be determined when the object enters into a predetermined range from the vehicle or the remote vehicle control device.

In the remote vehicle control device, approach of the object to the vehicle or the remote vehicle control device may be determined on the basis of the distance from the vehicle or the remote vehicle control device to the object and the movement velocity of the object.

In the remote vehicle control device, the communication unit may receive information detected in the vehicle and related to approach of the object to the vehicle or the remote vehicle control device, from the vehicle.

In the remote vehicle control device, the communication unit may receive information related to a tilted state of the vehicle, from the vehicle, and the display unit may display the information related to the tilted state.

In the remote vehicle control device, the communication unit may receive information related to a steering angle of the vehicle, from the vehicle, and the display unit may display the information related to the steering angle.

In the remote vehicle control device, the display unit may display images acquired by imaging an area above the vehicle.

According to an aspect of the present disclosure, there is provided a remote vehicle control method including: generating each of synthetic images showing a surrounding area of a vehicle as seen from a virtual viewpoint and including the surrounding area of the remote vehicle control device, on the basis of plural images acquired by plural on-board cameras mounted on the vehicle, respectively; displaying the synthetic images on a remote vehicle control device; receiving operations for the vehicle on the remote vehicle control device; generating control signals for the vehicle, on the basis of the operations; and transmitting the control signals from the remote vehicle control device to the vehicle.

According to the configuration of the present invention, it is possible to check the surrounding area of the vehicle over a wide range, on synthetic images which are displayed on the mobile terminal. Also, it is possible to quickly grasp existence of objects approaching the vehicle and the user remotely controlling the vehicle, on the synthetic images. In other words, it is possible to improve convenience and operability in remote control on the vehicle.

### BRIEF DESCRIPTION OF THE DRAWINGS

Exemplary embodiments of the present invention will be described in detail based on the following figures, wherein:

FIG. 1 is a block diagram illustrating the configuration of a remote vehicle control system of an embodiment;

FIG. 2 is a view illustrating positions on a vehicle where on-board cameras which are disposed;

FIG. 3 is a view for explaining a method of generating synthetic images showing the surrounding area of the vehicle;

FIG. 4 is a schematic diagram illustrating a mobile terminal displaying a synthetic image according to a first example (Example 1);

FIG. 5 is a schematic diagram illustrating a synthetic image displayed on the mobile terminal according to the first example;

FIG. 6 is a schematic diagram illustrating the mobile terminal displaying a synthetic image according to the first example (Example 2);

FIG. 7 is a schematic diagram illustrating the mobile terminal displaying a synthetic image according to the first example (Example 3);

FIG. 8 is a flow chart illustrating an example of the flow of processing of the mobile terminal related to remote vehicle control according to the first example;

FIG. 9 is a flow chart illustrating another example of the flow of processing of the mobile terminal related to remote vehicle control according to the first example;

FIG. 10 is a schematic diagram of a mobile terminal displaying a synthetic image and an auxiliary image according to a second example;

FIG. 11 is a schematic diagram illustrating a synthetic image displayed on a mobile terminal according to a third example;

FIG. 12 is a view illustrating positions on the vehicle where on-board cameras are disposed according to a fourth example;

FIG. 13 is a schematic diagram illustrating a mobile terminal displaying a synthetic image and an auxiliary image according to the fourth example; and

FIG. 14 is a block diagram illustrating the configuration of a remote vehicle control system of a fifth example.

### DETAILED DESCRIPTION

Hereinafter, exemplary embodiments of the present invention will be described in detail with reference to the drawings. However, the present invention is not limited to the contents of the embodiments to be described below.

Also, in the following description, in the straight advancing direction of a vehicle, the direction from the driver's seat toward the steering wheel is referred to as the forward direction (the front side). In the straight advancing direction of the vehicle, the direction from the steering wheel toward the driver's seat is referred to as the backward direction (the rear side). In the direction perpendicular to the straight advancing direction of the vehicle and the vertical direction, the direction from the right side of the driver facing forward to the left side is referred to as the left direction. In the direction perpendicular to the straight advancing direction of the vehicle and the vertical direction, the direction from the left side of the driver facing forward to the right side is referred to as the right direction.

### 1. Configuration of Remote Vehicle Control System

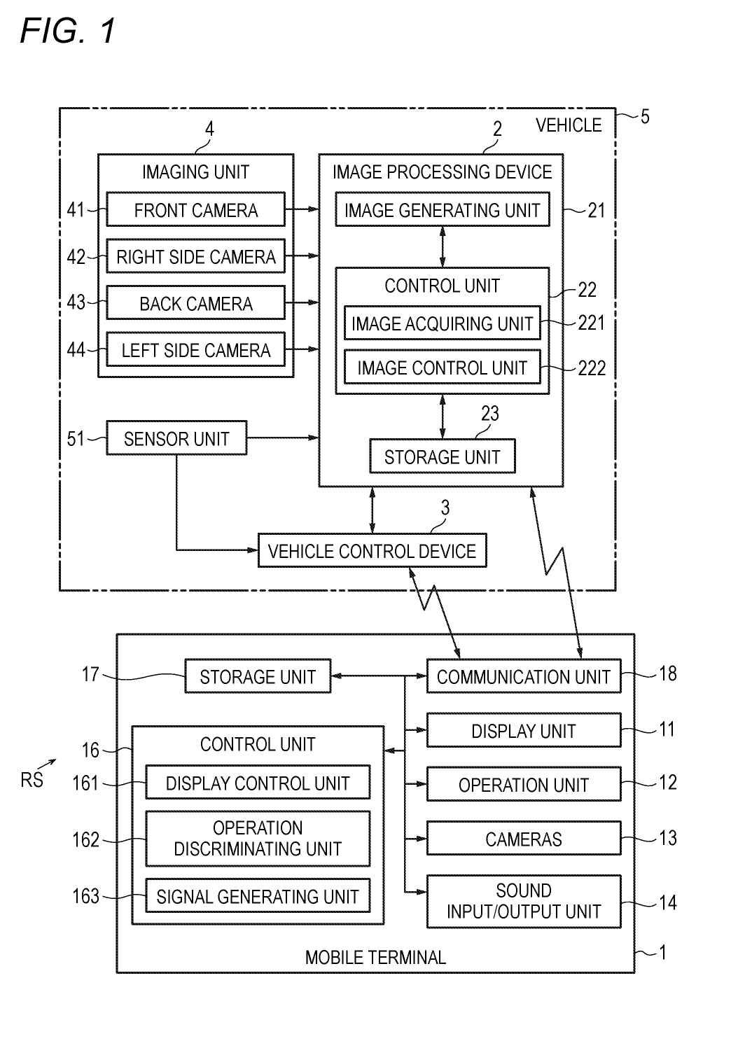

FIG. 1 is a block diagram illustrating the configuration of a remote vehicle control system RS of an embodiment. The remote vehicle control system RS includes a mobile terminal 1, an image processing device 2, and a vehicle control device 3. The mobile terminal 1 is a remote vehicle control device for remotely controlling a vehicle 5. The image processing device 2 and the vehicle control device 3 are mounted on the vehicle 5. The remote vehicle control system RS is a system for remotely controlling the vehicle 5 by the mobile terminal 1 capable of displaying synthetic images showing the surrounding area of the vehicle 5. The vehicle 5 further includes an imaging unit 4 (on-board cameras) and a sensor unit 51.

The mobile terminal 1 is a device configured to receive images for display which are output from the image processing device 2, and display the images, and transmits control signals to the vehicle control device 3, to remotely control the vehicle 5. Examples of the mobile terminal 1 include smart phones, tablet type terminals, and so on belonging to the owner of the vehicle 5 and so on. In the present embodiment, the mobile terminal 1 is, for example, a smart phone.

The image processing device 2 is a device configured to process images acquired by the on-board cameras. For each vehicle equipped with on-board cameras, an image processing device 2 is provided. In the present embodiment, the image processing device 2 acquires images from the imaging unit 4, and processes the images. Also, the image processing device 2 may acquire information from the sensor unit 51, and perform determinations related to image processing on the basis of the acquired information. Also, the image processing device 2 transmits information to the mobile terminal 1 and the vehicle control device 3, and receives information from them. The image processing device 2 may output images for display generated by the image processing device 2, to the mobile terminal 1.

The vehicle control device 3 performs control on the general operation of the vehicle. The vehicle control device 3 includes, for example, an engine ECU (Electronic Control Unit) for controlling the engine, a steering ECU for controlling the steering, a brake ECU for controlling the brake, a shift ECU for controlling the shift, a power source control ECU for controlling the power source, a light ECU for controlling the lights, a mirror ECU for controlling the electric mirrors, and so on. In the present embodiment, the vehicle control device 3 transmits information to the mobile terminal 1 and the image processing device 2, and receives information from them. The vehicle control device 3 receives control signals for the vehicle 5, from the mobile terminal 1, and controls the vehicle 5 on the basis of the control signals.

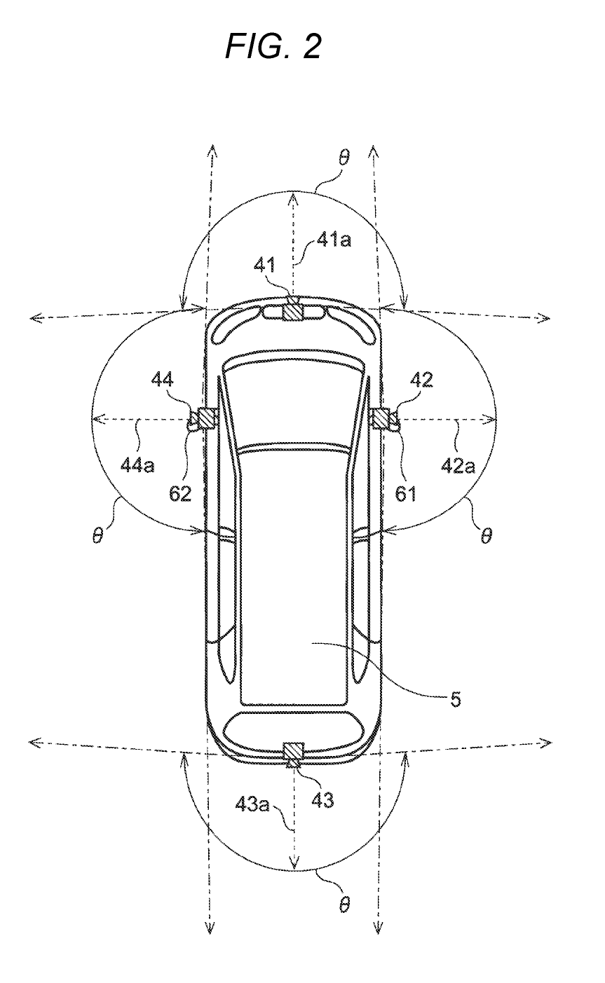

The imaging unit 4 is provided for monitoring the condition around the vehicle. The imaging unit 4 includes, for example, four on-board cameras 41 to 44. FIG. 2 is a view illustrating positions on the vehicle 5 where the on-board cameras 41 to 44 are disposed.

The on-board camera 41 is installed on the front end of the vehicle 5. Therefore, the on-board camera 41 is also referred to as the front camera 41. The optical axis 41a of the front camera 41 extends along the longitudinal direction of the vehicle 5 as seen in a plan view illustrating the vehicle as seen from the above. The front camera 41 images the area in front of the vehicle 5. The on-board camera 43 is installed on the rear end of the vehicle 5. Therefore, the on-board camera 43 is also referred to as the back camera 43. The optical axis 43a of the back camera 43 extends along the longitudinal direction of the vehicle 5 as seen in a plan view illustrating the vehicle as seen from the above. The back camera 43 images the area behind the vehicle 5. It is preferable that the installation positions of the front camera 41 and the back camera 43 be at the center in the width direction of the vehicle 5; however, the front camera and the back camera may be slightly deviated to the left or the right from the center in the width direction.

The on-board camera 42 is installed on a right mirror 61 of the vehicle 5. Therefore, the on-board camera 42 is also referred to as the right side camera 42. The optical axis 42a of the right side camera 42 extends along the width direction of the vehicle 5 as seen in a plan view illustrating the vehicle as seen from the above. The right side camera 42 images the area on the right side of the vehicle 5. The on-board camera 44 is installed on a left mirror 62 of the vehicle 5. Therefore, the on-board camera 44 is also referred to as the left side camera 44. The optical axis 44a of the left side camera 44 extends along the width direction of the vehicle 5 as seen in a plan view illustrating the vehicle as seen from the above. The left side camera 44 images the area on the left side of the vehicle 5.

However, in the case where the vehicle 5 is a so-called door-mirror-less vehicle, the right side camera 42 may be installed in the vicinity of the pivot (hinge part) of the right side door, without interposing a door mirror therebetween, and the left side camera 44 may be installed in the vicinity of the pivot (hinge part) of the left side door, without interposing a door mirror therebetween.

As lenses for the on-board cameras 41 to 44, for example, fisheye lenses are used. Each of the on-board cameras 41 to 44 has an angle of view θ equal to or greater than 180 degrees in the horizontal direction. Therefore, it is possible to image the area around the vehicle 5 in the horizontal direction.

FIG. 1 will be further described. The sensor unit 51 includes plural sensors for detecting information related to the vehicle 5 equipped with the on-board cameras 41 to 44. In information related to the vehicle 5, information on the vehicle and information on the surrounding area of the vehicle may be included. In the present embodiment, in the sensor unit 51, for example, a vehicle velocity sensor for detecting the velocity of the vehicle, a steering angle sensor for detecting the rotation angle of the steering, a shift sensor for detecting the operation position of the shift lever of the transmission of the vehicle, an illuminance sensor for detecting the illuminance in the surrounding area of the vehicle, a vibration sensor for detecting vibration of the vehicle, a tilt sensor for detecting the tilt of the vehicle, obstacle sensors for detecting people, animals, vehicles, and other objects in the surrounding area of the vehicle, and so on are included.

The obstacle sensors may use, for example, ultrasonic sensors, light sensors using infrared light or the like, radars, and the like to detect people, animals, vehicles, and other objects in the surrounding area of the vehicle. The obstacle sensors are embedded at plural positions, for example, in the front bumper, the rear bumper, the doors, and so on of the vehicle 5. The obstacle sensors transmit transmission waves toward the surrounding area of the vehicle, and receive waves reflected from people, other vehicles, and so on, to detect whether there are objects such as people, other vehicles, and so on, and the directions and positions of objects.

### 2. Configuration of Mobile Terminal

The mobile terminal 1 is configured to include a display unit 11, an operation unit 12, cameras 13, a sound input/output unit 14, a control unit 16, a storage unit 17, and a communication unit 18.

The display unit 11 is disposed on the front surface of the mobile terminal 1 which is a smart phone. In the present embodiment, the display unit 11 has a touch panel, as a part of the operation unit 12, on the front surface, and the touch panel is, for example, a liquid crystal display panel. The display unit 11 displays, for example, images for display output from the image processing device 2, on the screen.

The operation unit 12 includes, for example, the touch panel provided on the front surface of the display unit 11, other operation buttons, and so on. The operation unit 12 is configured such that a user may input information from the outside, i.e. the user may perform operations such as operations of inputting characters, numbers, and so on, operations of selecting a menu or a choice, and operations for performing or canceling a process. In the present embodiment, the operation unit 12 is a touch panel usable to operate the vehicle 5. However, the operation unit 12 is not limited to software keys using a touch panel or the like, and may be hardware keys provided as physical input units on the mobile terminal 1.

The cameras 13 are disposed on the front surface and rear surface of the mobile terminal 1 which is a smart phone. The front camera 13 images the front surface side of the surrounding area of the mobile terminal 1. The rear camera 13 images the rear surface side of the surrounding area of the mobile terminal 1.

The sound input/output unit 14 includes, for example, a microphone and a speaker. The microphone acquires information on sounds around the mobile terminal 1, including sound which is uttered by the user. The speaker emits notifying sound, sound on a communication line, and so on to the outside.

The control unit 16 is a so-called microcomputer including a CPU (Central Processing Unit), a RAM (Random Access Memory), and a ROM (Read Only Memory) (not shown in the drawings). The control unit 16 performs information processing and information transmission and reception on the basis of a program stored in the storage unit 17. The control unit 16 is connected to the display unit 11, the operation unit 12, the cameras 13, the sound input/output unit 14, the storage unit 17, and the communication unit 18 by wire.

The control unit 16 includes a display control unit 161, an operation discriminating unit 162, and a signal generating unit 163. The CPU performs arithmetic processing according to a program, whereby the functions of the individual components of the control unit 16 are implemented.

The display control unit 161 controls display contents of the display unit 11. For example, if receiving inputs for performing and setting various functions of the mobile terminal 1, the display control unit 161 controls the display unit 11 such that the display unit displays function images related to the functions. The function images are images corresponding to various functions of the mobile terminal 1, and includes, for example, icons, buttons, software keys, slide bars, slide switches, check boxes, text boxes, and so on. The user may select the function images displayed on the display unit 11 by touching the touch panel (the operation unit 12), thereby performing and setting various functions of the mobile terminal 1.

The operation discriminating unit 162 receives detection signals output from the touch panel (the operation unit 12), and discriminates the contents of operations performed on the touch panel, on the basis of the detection signals. The operation discriminating unit 162 discriminates operations such as tapping, dragging, flicking, and so on, besides information on positions on the touch panel. In the case of operations using moving, such as dragging and flicking, the operation discriminating unit also discriminates the movement directions, the movement distances, and so on.

The signal generating unit 163 generates control signals for the vehicle 5, on the basis of operations on the operation unit 12. The generated control signals for the vehicle 5 are transmitted to the vehicle 5 via the communication unit 18.

The storage unit 17 is a non-volatile memory such as a flash memory, and stores a variety of information. The storage unit 17 stores, for example, programs which are firmware, a variety of data necessary for the control unit 16 to perform various functions, and so on.

The communication unit 18 may be connected to various external devices, for example, wirelessly. The mobile terminal 1 may receive images for display generated by the image processing device 2 of the vehicle 5, and a variety of information (the steering angle, the shift position, the traveling velocity, obstacle information, and so on) detected by the sensor unit 51 of the vehicle 5, via the communication unit 18. The mobile terminal 1 may transmit control signals for the vehicle 5 based on operations on the operation unit 12, to the vehicle 5 via the communication unit 18.

### 3. Configuration of Image Processing Device

The image processing device 2 is configured to include an image generating unit 21, a control unit 22, and a storage unit 23.

The image generating unit 21 generates images for display by processing images acquired by the imaging unit 4. In the present embodiment, the image generating unit 21 is configured as a hardware circuit capable of a variety of image processing. In the present embodiment, the image generating unit 21 generates synthetic images showing the surrounding area of the vehicle 5 as seen from virtual viewpoints, on the basis of images acquired by the on-board cameras 41 to 44 mounted on the vehicle 5. Further, the image generating unit 21 generates images for display to be displayed on the mobile terminal 1, on the basis of the synthetic images. Details of the method of generating synthetic images will be described below.

The control unit 22 is a so-called microcomputer including a CPU, a RAM, and a ROM (not shown in the drawings). The control unit 22 performs information processing and information transmission and reception on the basis of a program stored in the storage unit 23. The control unit 22 is connected to the mobile terminal 1, the vehicle control device 3, the imaging unit 4, and the sensor unit 51 by wire or wirelessly.

The control unit 22 includes an image acquiring unit 221 and an image control unit 222. The CPU performs arithmetic processing according to a program, whereby the functions of the individual components of the control unit 22 are implemented.

The image acquiring unit 221 acquires images acquired by the on-board cameras 41 to 44. In the present embodiment, the number of on-board cameras 41 to 44 is four, and the image acquiring unit 221 acquires images acquired by the individual on-board cameras 41 to 44.

The image control unit 222 controls image processing which is performed by the image generating unit 21. For example, the image control unit 222 issues instructions related to various parameters necessary to generate synthetic images and images for display, to the image generating unit 21. Also, the image control unit 222 performs control to output images for display generated by the image generating unit 21 to the mobile terminal 1. However, in this description, images for display which are related to synthetic images and are displayed on the display unit 11 of the mobile terminal 1 are also referred to simply as synthetic images.

The storage unit 23 is a non-volatile memory such as a flash memory, and stores a variety of information. The storage unit 23 stores, for example, programs which are firmware, a variety of data necessary for the image generating unit 21 to generate synthetic images and images for display. Also, the storage unit 23 stores a variety of data necessary for the image acquiring unit 221 and the image control unit 222 to perform processing.

### 4. Generation of Synthetic Images

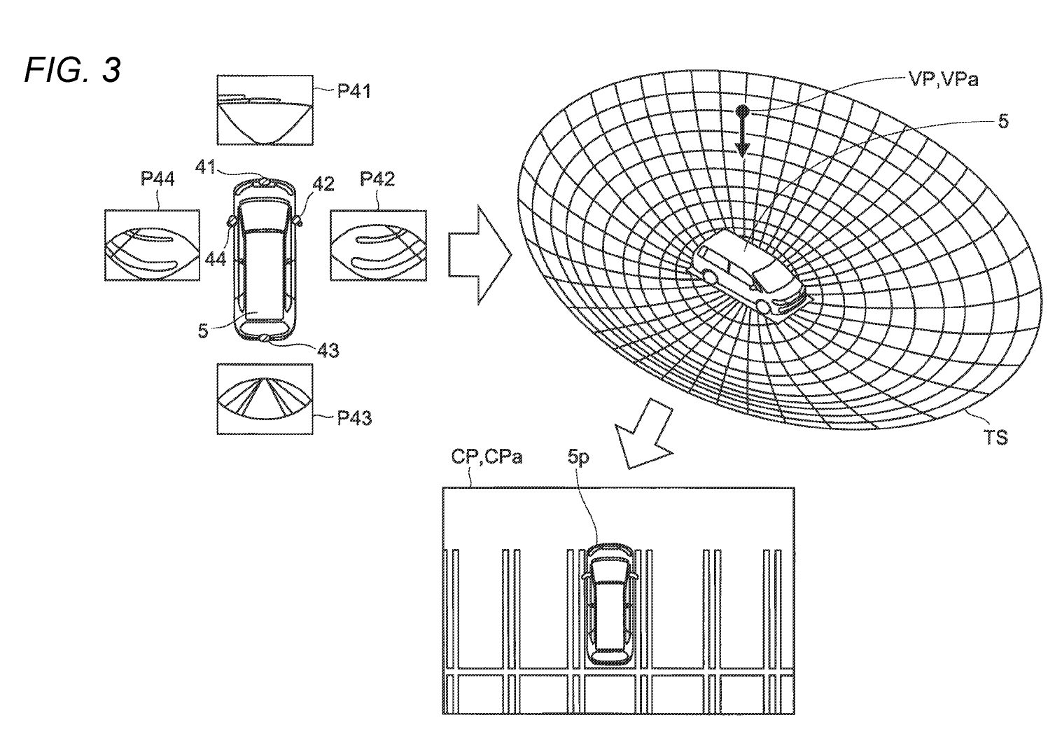

The method by which the image generating unit 21 generates synthetic images showing the condition in the surrounding area of the vehicle 5 as seen from virtual viewpoints will be described. FIG. 3 is a view for explaining the method of generating synthetic images CP showing the surrounding area of the vehicle 5.

By the front camera 41, the right side camera 42, the back camera 43, and the left side camera 44, four images P41 to P44 showing the front side, the right side, the rear side, and the left side of the vehicle 5 respectively are acquired at the same time. In the four images P41 to P44, data on all over the surrounding area of the vehicle 5 is included. The image generating unit 21 acquires the four images P41 to P44 via the image acquiring unit 221.

The image generating unit 21 projects the data included in the four images P41 to P44 (the values of the individual pixels), onto a projection plane TS which is a three-dimensional curved plane in a virtual three-dimensional space. The projection plane TS has, for example, a substantially hemispherical shape (a bowl shape), and the center thereof (a bottom part of the bowl) is determined as the position of the vehicle 5.

Onto an area of the projection plane TS on the outside of the area for the vehicle 5, the image data is projected. The correspondence relation between the positions of the individual pixels which are included in the images P41 to P44 and the positions of the individual pixels on the projection plane TS is determined in advance. Table data representing that correspondence relation is stored in the storage unit 23. The values of the individual pixels on the projection plane TS may be determined on the basis of the above-mentioned correspondence relation and the values of the individual pixels included in the images P41 to P44.

Next, the image generating unit 21 sets a virtual viewpoint VP in the three-dimensional space under the control of the image control unit 222. The virtual viewpoint VP is defined by a viewpoint position and a sight line direction. The image generating unit 21 may set a virtual viewpoint VP having an arbitrary viewpoint position and an arbitrary sight line direction, in the three-dimensional space. The image generating unit 21 extracts data projected onto an area of the projection plane TS included in the field of view as seen from the set virtual viewpoint VP, as an image. In this way, the image generating unit 21 generates synthetic images as seen from arbitrary virtual viewpoints VP.

For example, as shown in FIG. 3, in the case of assuming a virtual viewpoint VPa defined by a viewpoint position which is right above the vehicle 5 and a sight line direction which is a straight downward direction, it is possible to generate a synthetic image (a bird's eye view image) CPa showing the vehicle 5 and the surrounding area of the vehicle 5.

An image 5p of the vehicle 5 which is shown in the synthetic image CPa is prepared as data such as a bitmap and is stored in the storage unit 23, in advance. When the synthetic image CPa is generated, the data of the image 5p of the vehicle 5 having a shape according to the viewpoint position and the sight line direction defining the virtual viewpoint VP of the synthetic image is read out, and is included in the synthetic image CPa.

As described above, the image generating unit 21 may generate realistic synthetic images CPa, using the virtual three-dimensional projection plane TS.

Also, it is possible to check the surrounding area of the vehicle 5, using each synthetic image CP showing the surrounding area of the vehicle 5, generated on the basis of plural images acquired by the plural on-board cameras 41 to 44 mounted on the vehicle 5. Therefore, it is also possible to check blind areas from the position of the user, such as an area on the opposite side of the vehicle 5 screened by the vehicle 5 as seen from the position of the user.

### FIRST EXAMPLE

### 5. Examples of Remote Vehicle Control Using Mobiles Terminal

### 5-1. First Example

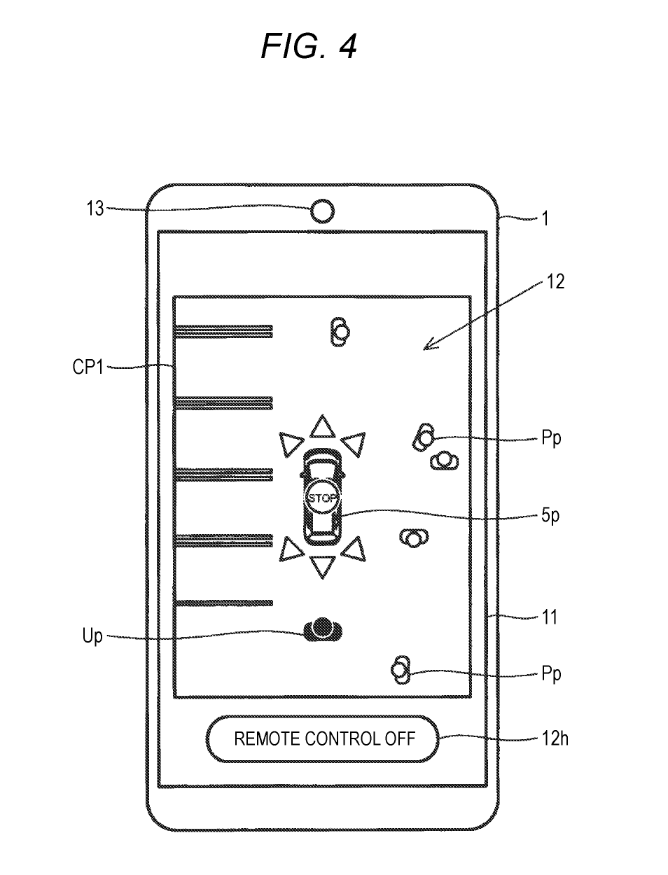

The mobile terminal 1 may receive synthetic images showing the surrounding area of the vehicle 5 as seen from virtual viewpoints, generated by the image processing device 2 of the vehicle 5. The mobile terminal 1 may display the synthetic images on the display unit 11. FIG. 4 is a schematic diagram illustrating the mobile terminal 1 displaying a synthetic image CP1 according to a first example (Example 1). The synthetic image CP1 is, for example, a bird's eye view image showing the surrounding area of the vehicle 5.

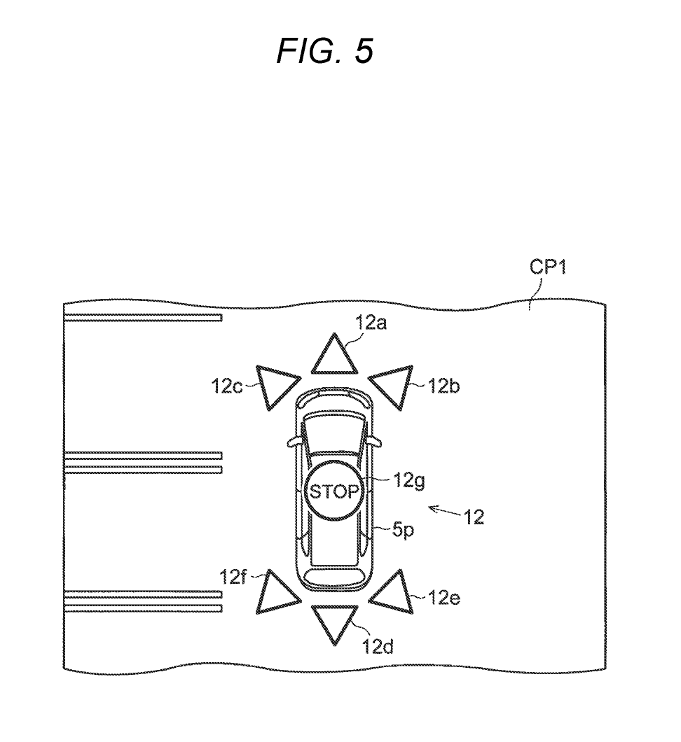

FIG. 5 is a schematic diagram illustrating the synthetic image CP1 displayed on the mobile terminal 1 according to the first example. However, FIG. 5 shows a part of the entire synthetic image CP1 around the image 5p of the vehicle 5. As shown in FIG. 5, on the occasion of remotely controlling the vehicle 5, the mobile terminal 1 displays the icons and so on which are function images related to remote control on the vehicle 5, on the display unit 11. In other words, on the synthetic image CP1, the icons and so on which are images of the operation unit 12 are superimposed. The operation unit 12 is disposed according to the position and orientation of the image 5p of the vehicle 5 in the synthetic image CP1.

Specifically, on the screen of the display unit 11, for example, an icon 12a related to forward traveling, an icon 12b related to the front right side, an icon 12c related to the front left side, an icon 12d related to backward traveling, an icon 12e related to the rear right side, and an icon 12f related to the rear left side are displayed so as to overlap the bird's eye view image CP1. These icons related to traveling of the vehicle 5 are disposed, for example, around the image 5p of the vehicle 5, according to positions and directions corresponding to individual traveling directions, respectively. In the present example, the icons indicating the traveling directions of the vehicle 5 are configured, for example, in a triangular shape; however, they may be configured in any other shape such as an arrow shape.

Also, a “STOP” icon 12g related to stopping of the vehicle 5 is disposed so as to overlap the image 5p of the vehicle 5. Further, outside the bird's eye view image CP1, an icon 12h for ending remote control on the vehicle 5 is displayed.

The user may arbitrarily operate the icons with fingers. The operation discriminating unit 162 discriminates the contents of operations corresponding to the icons on the basis of detection signals of the touch panel (the operation unit 12). The signal generating unit 163 generates control signals for the vehicle 5, on the basis of the operation contents corresponding to the icons. The control signals are transmitted to the vehicle 5 via the communication unit 18.

For example, if the user presses (touches) the icon 12a related to forward traveling of the vehicle 5 once, the vehicle 5 travels forward by a predetermined distance (for example, 10 cm). Also, for example, if the user presses the icon 12c related to the front left side of the vehicle 5, the vehicle 5 changes the steering angle by a predetermined angle such that the vehicle travels to the front left side. In this configuration, whenever changing the steering angle, the orientation of the image 5p of the vehicle 5 may be changed such that it is possible to easily grasp which direction the vehicle is turning to. Subsequently, if the user presses the icon 12a related to forward traveling once, the vehicle 5 travels to the front left side by a predetermined distance. However, the movement direction, traveling distance, and so on may be controlled on the basis of operations using moving which is performed on the touch panel (the operation unit 12), such as dragging and flicking.

In the case where the user wants to stop the vehicle 5 when the vehicle is traveling, if the user presses the “STOP” icon 12g related to stopping of the vehicle 5, the vehicle 5 stops. Alternatively, the vehicle 5 may travel only when the user is pressing the icon 12a related to forward traveling or the icon 12d related to backward traveling, and if the user removes the finger from the icon 12a or the icon 12d, the vehicle 5 may stop.

Further, the user may perform operations such as an operation for changing the viewpoint position, the sight line direction, and the zoom related to a synthetic image displayed on the display unit 11, via the operation unit 12.

During remote control, obstacles around the vehicle 5, such as people, animals, vehicles, and other objects, are detected by the sensor unit 51 of the vehicle 5. If the sensor unit 51 detects any obstacle, a detection signal is transmitted to the vehicle control device 3, and the vehicle control device 3 automatically stops the vehicle 5.

Also, as shown in FIG. 4, on the occasion of displaying a synthetic image CP1 on the screen, the display unit 11 displays a synthetic image including the surrounding area of the vehicle 5 over a wide range. Therefore, for example, the surrounding area of an image Up of the user carrying the mobile terminal 1 is also included in the synthetic image CP1. In other words, the display unit 11 displays a synthetic image CP1 including the surrounding area of the mobile terminal 1.

In the synthetic image CP1, images Pp of people, including the image Up of the user, are included. Therefore, the mobile terminal 1 highlights the image Up of the user against the images Pp of the other people such that the image Up may be easily recognized. For example, the display unit 11 displays the image Up of the user in a color different from the color of the images Pp of the other people. In this way, the display unit 11 displays the location of the mobile terminal 1 on the synthetic image CP1. Alternatively, the location of the mobile terminal 1, i.e. the position of the image Up of the user may be highlighted by making a mark such as an arrow.

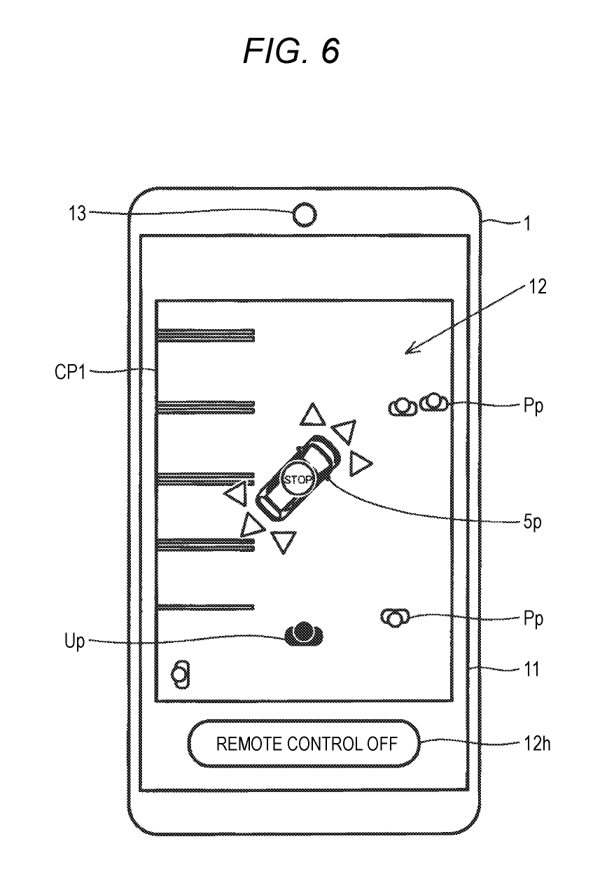

Subsequently, in the case where remote control has been performed such that the vehicle 5 travels, the synthetic image CP1 is displayed in a state shown in FIG. 6. FIG. 6 is a schematic diagram illustrating the mobile terminal 1 displaying a synthetic image CP1 according to the first example (Example 2). In the case where the vehicle is traveling, the image of the entire range included in the synthetic image CP1 does not change, but the image 5p of the vehicle 5 moves. In other words, as long as the user carrying the mobile terminal 1 does not move, in synthetic images CP1, the position of the image Up of the user does not change, and the image of the road showing the shape of the road also does not change.

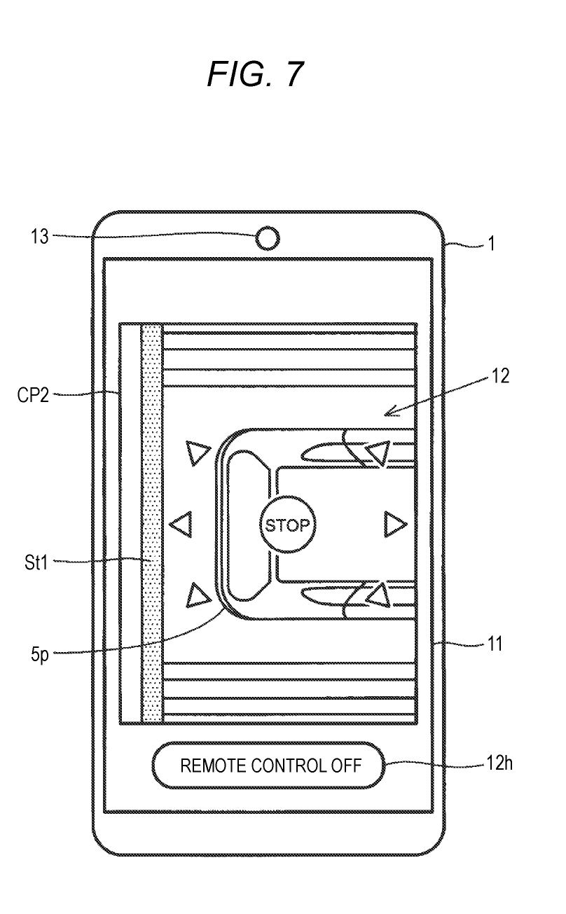

Also, if it is detected that any other object is approaching the vehicle 5 and the mobile terminal 1, the display unit 11 displays synthetic images showing the surrounding area of the object approaching the vehicle 5 and the mobile terminal 1 in a larger size. FIG. 7 is a schematic diagram illustrating the mobile terminal displaying a synthetic image CP2 according to the first example (Example 3). In the present example, for example, it is assumed that when the vehicle 5 is being backed into a parking space to park, it is detected that a wall St1 is approaching the vehicle 5 from behind.

If approach of the wall St1 to the vehicle 5 is detected, the image generating unit 21 generates synthetic images CP2 showing the surrounding area of the wall St1 approaching the vehicle 5, in larger sizes. The synthetic images CP2 are, for example, bird's eye view images showing the surrounding area of the wall St1 approaching the vehicle 5. In each synthetic image CP2, not only an image of the wall St1 but also an image 5p of a part of the vehicle 5 close to the wall St1 is included. The mobile terminal 1 receives the synthetic images CP2 from the image processing device 2, and displays the synthetic images CP2 on the display unit 11.

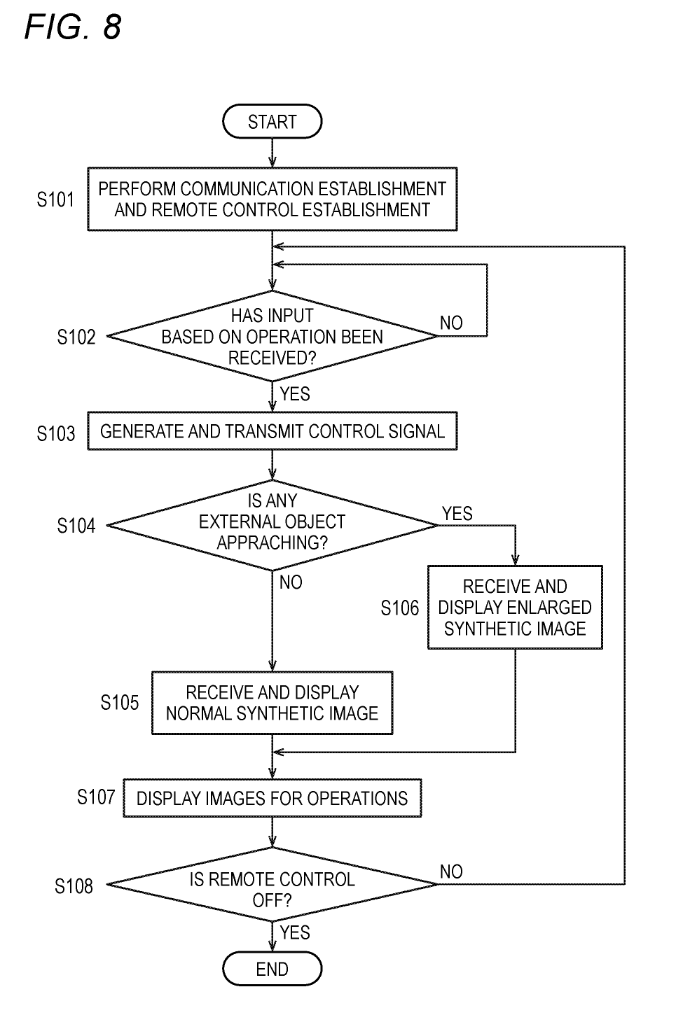

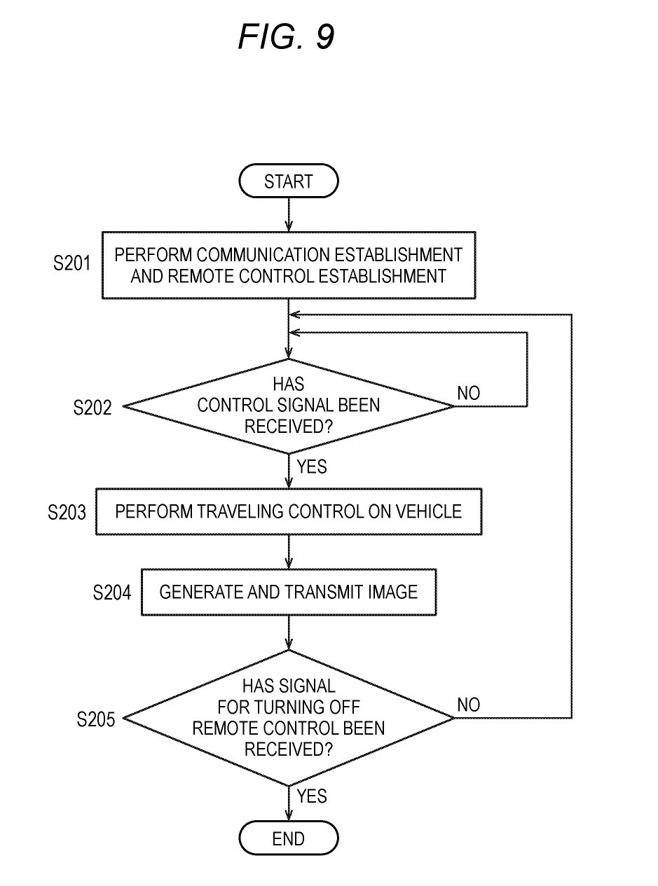

FIG. 8 is a flow chart illustrating an example of the flow of processing of the mobile terminal 1 related to remote vehicle control according to the first example. FIG. 9 is a flow chart illustrating another example of the flow of processing of the mobile terminal 1 related to remote vehicle control according to the first example. The processing which is related to remote control on the vehicle 5 and is performed by the mobile terminal 1 according to the first example will be described with reference to the processing flows of FIG. 8 and FIG. 9.

For example, if the mobile terminal 1 is operated by the user, and receives a remote control start instruction from the operation unit 12, the processing of the mobile terminal 1 related to remote control on the vehicle 5 is started (“START” of FIG. 8). Remote control on the vehicle 5 is started when the vehicle 5 is stopped.

Subsequently, the mobile terminal 1 performs a communication establishment process and a remote control establishment process in cooperation with the vehicle 5 (STEP S101). At this time, even in the vehicle 5, processing related to remote control is started (“START” of FIG. 9), and the communication establishment process and the remote control establishment process are performed in cooperation with the mobile terminal 1 (STEP S201). In these steps, for example, a process of matching the mobile terminal 1 and the vehicle 5, a control permission process, and so on are performed. In the control permission process, for example, an authentication process on an ID, a password, and so on is performed.

Next, the mobile terminal 1 determines whether an input based on a user's operation on the operation unit 12 has been received (STEP S102 of FIG. 8). Examples of a user's operation include an operation for performing remote control related to traveling of the vehicle 5, an operation for changing the viewpoint position, the sight line direction, or the zoom related to a synthetic image CP1, an operation for selecting a display mode, and so on.

In the case where an input based on an operation on the operation unit 12 has been received (“Yes” in STEP S102 of FIG. 8), the mobile terminal 1 generates a control signal based on the operation on the operation unit 12 by the signal generating unit 163, and transmits the control signal to the vehicle 5 (STEP S103). In this way, the user may perform remote control on the vehicle 5.

In the vehicle 5, whether any control signal related to remote control on the vehicle 5 has been received is determined (STEP S202 of FIG. 9). In the case where the vehicle 5 has received a control signal (“Yes” in STEP S202), for example, if the control signal is a signal related to traveling control, the vehicle control device 3 controls traveling of the vehicle 5 on the basis of the control signal (STEP S203).

In the case where the control signal received by the vehicle 5 is a signal related to image generation, the image processing device 2 generates an image on the basis of the control signal, and transmits the image to the mobile terminal 1 (STEP S204). The image processing device 2 acquires plural images of the surrounding area of the vehicle 5 from the on-board cameras 41 to 44, respectively. The image generating unit 21 generates a synthetic image CP1 showing the surrounding area of the vehicle 5 as seen a virtual viewpoint, on the basis of the plural images of the surrounding area of the vehicle 5.

Next, whether approach of any external object to the vehicle 5 or the mobile terminal 1 has been detected is determined (STEP S104). People, animals, vehicles, and other objects existing in the vicinities of the vehicle 5 and the mobile terminal 1 are detected, for example, on the basis of the detection signals of the ultrasonic sensors, the light sensors, and the radars included in the sensor unit 51, or image recognition using images of the on-board cameras 41 to 44. With respect to such other objects, for example, information such as the distances to the objects, the movement velocities of the objects, and so on may be obtained.

Specifically, for example, approach of any external object to the vehicle 5 or the mobile terminal 1 is determined, for example, when the object is in a predetermined range from the vehicle 5 or the mobile terminal 1. It is possible to arbitrarily set a range such as a range up to 10 m in the radial direction, as the predetermined range from the vehicle 5 or the mobile terminal 1.

Also, approach of any other external object to the vehicle 5 or the mobile terminal may be determined, for example, on the basis of the distances from the vehicle 5 or the mobile terminal 1 to the object, and the movement velocity of the object. On the basis of the distance to the object and the movement velocity of the object, the estimated time of arrival when the object is expected to arrive the vehicle 5 or the mobile terminal 1 is calculated. For example, in the case where the estimated time of arrival (=[Distance to Object]/[Movement Velocity of Object]) is within 10 seconds, approach of the object to the vehicle 5 or the mobile terminal 1 is determined. The estimated time of arrival may be set to an arbitrary time.

In the case where approach of any other external object to the vehicle 5 or the mobile terminal 1 has not been detected (“No” in STEP S104), the mobile terminal 1 receives a synthetic image CP1 having a normal scale from the image processing device 2, and displays the synthetic image CP1 on the display unit 11 (STEP S105). For example, the synthetic images CP1 shown in FIG. 4 and FIG. 6 are synthetic images (bird's eye view images) having the normal scale. The display unit 11 displays a synthetic image CP1 including the surrounding area of the mobile terminal 1.

Meanwhile, for example, in the case where approach of an external object to the vehicle 5 has been detected (“Yes” in STEP S104), the mobile terminal 1 receives a synthetic image CP2 showing the surrounding area of the wall St1 approaching the vehicle 5 in a larger size, from the image processing device 2, and displays the synthetic image CP2 on the display unit 11 (STEP S106). For example, the synthetic image CP2 shown in FIG. 7 is a synthetic image (a bird's eye view image) showing the surrounding area of the wall St1 approaching the vehicle 5 in a larger size.

Next, the mobile terminal 1 displays the icons and so on (the operation unit 12) which are function images related to control on the vehicle 5, so as to overlap the synthetic images CP1 or the synthetic image CP2 (STEP S107). Therefore, the user may arbitrarily operate the icons for remote control with fingers.

Next, the mobile terminal 1 determines whether an operation for turning off remote control on the vehicle 5 has been performed by the user (STEP S108). The user may end remote control on the vehicle 5 by operating the icon 12h for ending remote control on the vehicle 5. In the case where an operation for turning off remote control has not been performed (“No” in STEP S108), the processing flow returns to STEP S102, and whether any other external object is approaching the vehicle 5 or the mobile terminal 1 is determined, and reception and display of one of synthetic images CP1 and CP2 are carried on.

In the case where an operation for turning off remote control has been performed (“Yes” in STEP S108), the processing flow of the mobile terminal 1 shown in FIG. 8 is ended.

In the vehicle 5, whether a control signal for turning off remote control on the vehicle 5 has been received is determined (STEP S205 of FIG. 9). In the case where a control signal for turning off remote control has not been received (“No” in STEP S205), the processing flow returns to STEP S202, and determination on whether a control signal related to remote control on the vehicle 5 has been received is carried on.

In the case where a control signal for turning off remote control has been received (“Yes” in STEP S205), the processing flow of the vehicle 5 shown in FIG. 9 is ended.

As described above, the mobile terminal 1 of the present example which is a remote vehicle control device displays synthetic images CP1 showing the surrounding area of the vehicle 5 as seen from virtual viewpoints and including the surrounding area of the mobile terminal 1, on the display unit 11. The communication unit 18 transmits control signals for the vehicle 5, to the vehicle 5. According to this configuration, it is possible to check the surrounding area of the vehicle 5 over a wide range, on synthetic images CP1 which are displayed on the mobile terminal 1. Also, it is possible to quickly grasp existence of objects approaching the vehicle 5 or the user remotely controlling the vehicle 5, on synthetic images CP1. In other words, it is possible to improve convenience and operability in remote control on the vehicle 5.

Further, the communication unit 18 receives synthetic images CP1 generated in the vehicle 5, from the vehicle 5. According to this configuration, it is possible to reduce the load of the mobile terminal 1. Therefore, it is possible to perform remote control using the mobile terminal 1, quickly and stably, and it is possible to improve convenience and operability in remote control on the vehicle 5.

Also, control signals for the vehicle 5 include signals related to control on the viewpoint positions and sight line directions of synthetic images CP1. According to this configuration, the user may see synthetic images CP1 based on various arbitrary viewpoint positions and various arbitrary sight line directions. Therefore, it is possible to improve convenience and operability in remote control on the vehicle 5.

Also, the display unit 11 of the mobile terminal 1 displays the location of the mobile terminal 1 on each synthetic image CP1. According to this configuration, the user may easily check the location of the mobile terminal 1, i.e. the location of the user on synthetic images CP1 which are displayed on the mobile terminal 1. Therefore, it is possible to more quickly grasp objects approaching the user. Therefore, it is possible to improve safety in remote control.

Further, if approach of any other object to the vehicle 5 or the mobile terminal 1 is detected, the display unit 11 displays synthetic images CP2 showing the surrounding area of the object approaching the vehicle 5 or the mobile terminal 1 in a larger size. According to this configuration, the user may remotely control the vehicle 5 while checking the appearances and behaviors of the wall St1 and other objects approaching the vehicle 5, on synthetic images CP2. Therefore, it is possible to improve safety in remote control. In other words, it is possible to improve convenience in remote control on the vehicle 5.

Also, approach of another object to the vehicle 5 or the mobile terminal 1 is determined, for example, when the object is in a predetermined range from the vehicle 5 or the mobile terminal 1. According to this configuration, if any other object is within the predetermined short distance from the vehicle 5 or the mobile terminal 1, synthetic images CP2 showing the surrounding area of the object in a larger size are displayed. Therefore, it is possible to prevent more synthetic images CP2 than necessary from being displayed, and it is possible to improve convenience in remote control on the vehicle 5.

Also, approach of any other object to the vehicle 5 or the mobile terminal 1 is determined on the basis of the distance from the vehicle 5 or the mobile terminal 1 and the movement velocity of the object. According to this configuration, the estimated time of arrival when the object is expected to reach the vehicle 5 or the mobile terminal 1 may be arbitrarily determined. In other words, in advance, it is possible to secure a responding time related to remote control on the vehicle 5 in the case where any other object approaches the vehicle 5 or the mobile terminal 1. Therefore, it is possible to improve convenience in remote control on the vehicle 5.

### SECOND EXAMPLE

### 5-2. Second Example

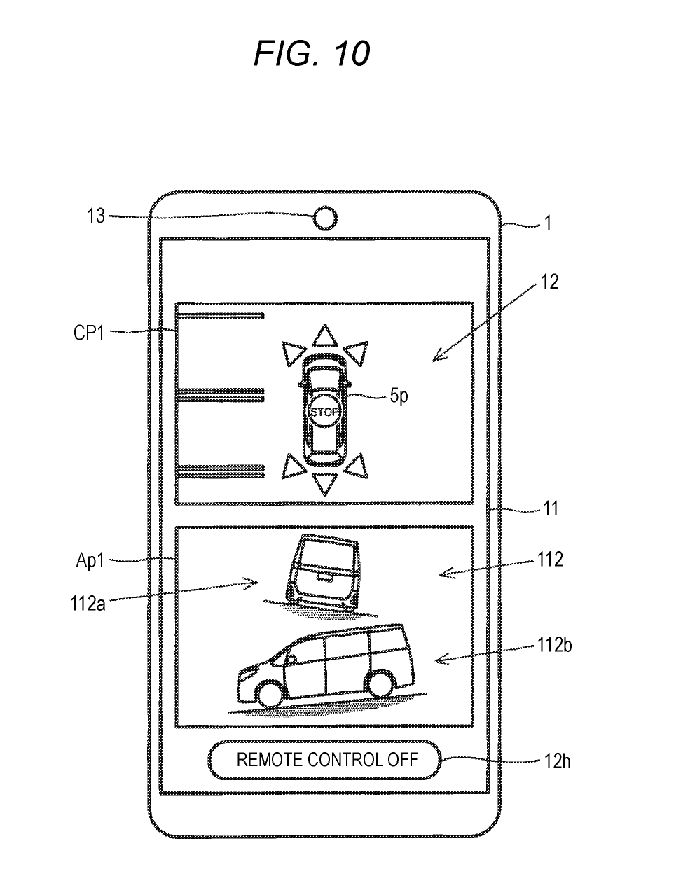

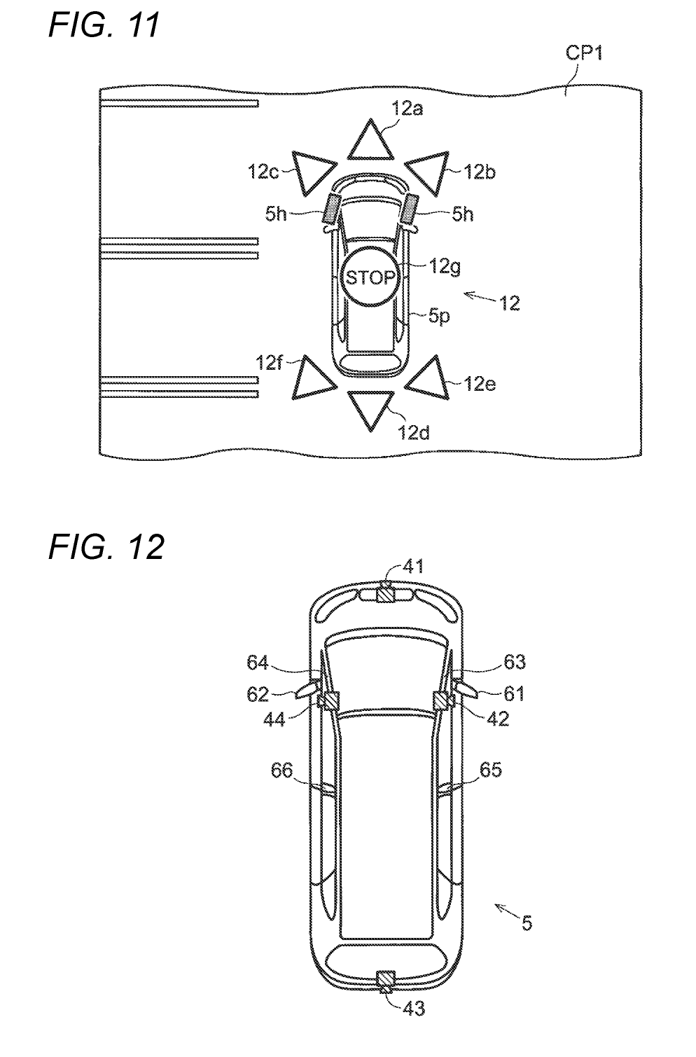

FIG. 10 is a schematic diagram illustrating the mobile terminal 1 displaying a synthetic image CP1 and an auxiliary image AP1 according to a second example. The mobile terminal 1 of the second example displays the plural icons related to remote control on the vehicle 5, as the operation unit 12, on the screen of the display unit 11, so as to overlap the synthetic image CP1.

Further, the display unit 11 of the mobile terminal 1 displays the auxiliary image AP1 below the synthetic image CP1. However, on the display unit 11, the arrangement of the synthetic image CP1 and the auxiliary image AP1 in the vertical direction may be changed. The display unit 11 displays an image 112 of information related to the tilted state of the vehicle 5, as the auxiliary image AP1. To this end, the communication unit 18 receives the information related to the tilted state of the vehicle 5, from the vehicle 5.

The image 112 of the information related to the tilted state of the vehicle 5 includes, for example, a width-direction tilt image 112a of the vehicle 5 and a longitudinal-direction tilt image 112b of the vehicle 5. The width-direction tilt image 112a is an image showing the tilted state of the actual vehicle 5 in the width direction. The longitudinal-direction tilt image 112b is an image showing the tilted state of the actual vehicle 5 in the longitudinal direction.

According to the configuration of the mobile terminal 1 of the present example, it is possible to check the tilted state of the actual vehicle 5 on the display unit 11 of the mobile terminal 1. Therefore, it is possible to easily check, for example, which direction the traveling velocity of the vehicle 5 is likely to increase in, or which direction the vehicle 5 is difficult to move to. Therefore, it is possible to improve safety in remote control. In other words, it is possible to further improve convenience and operability in remote control on the vehicle 5.

### THIRD EXAMPLE

### 5-3. Third Example

FIG. 10 is a schematic diagram illustrating the mobile terminal 1 displaying a synthetic image CP1 and an auxiliary image AP1 according to a third example. The mobile terminal 1 of the third example displays the plural icons related to remote control on the vehicle 5, as the operation unit 12, on the screen of the display unit 11, so as to overlap the synthetic image CP1.

Further, the display unit 11 of the mobile terminal 1 displays an image 5p of the vehicle 5 and images 5h of tiers of the vehicle 5 so as to overlap the synthetic image CP1. In other words, the display unit 11 displays the images 5h of the tires as information related to the steering angle of the vehicle 5. To this end, the communication unit 18 receives the information related to the steering angle of the vehicle 5, from the vehicle 5. The images 5h of the tires of the vehicle 5 are displayed so as to be oblique toward the width direction with respect to the longitudinal direction, on the basis of the steering angle of the actual vehicle 5.

According to the configuration of the mobile terminal 1 of the present example, it is possible to check the steering angle of the actual vehicle 5 on the display unit 11 of the mobile terminal 1. Therefore, it is possible to easily check the direction to which the tires of the vehicle 5 have been turned, and the angle by which the tires of the vehicle have been turned. Therefore, it is possible to improve safety in remote control. In other words, it is possible to further improve convenience and operability in remote control on the vehicle 5.

### FOURTH EXAMPLE

### 5-4. Fourth Example

FIG. 12 is a view illustrating positions on the vehicle where the on-board cameras are disposed according to a fourth example. In the fourth example, the on-board camera (the right side camera) 42 of the vehicle 5 is mounted on an A pillar 63 on the right side of the vehicle 5. However, the on-board camera (the right side camera) 42 may be mounted on a B pillar 65 on the right side. Also, in the fourth example, the on-board camera (the left side camera) 44 of the vehicle 5 is mounted on an A pillar 64 on the left side of the vehicle 5. However, the on-board camera (the left side camera) 44 may be mounted on a B pillar 66 on the left side.

Further, the angle of view of each of the on-board cameras 42 and 44 is 360°. Therefore, the on-board cameras 42 and 44 may image wide ranges in the vertical direction of the vehicle 5.

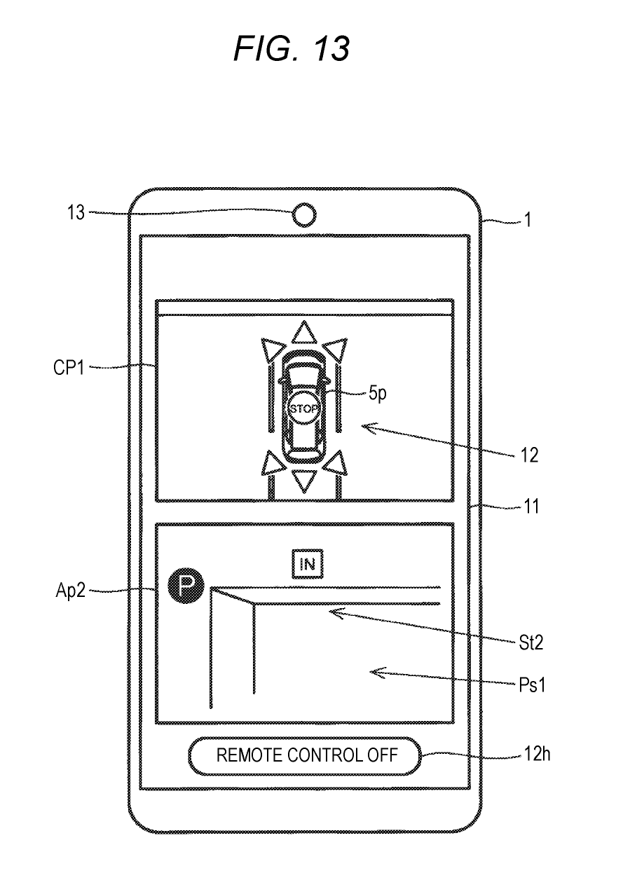

FIG. 13 is a schematic diagram illustrating the mobile terminal 1 displaying a synthetic image CP1 and an auxiliary image AP2 according to the fourth example. The mobile terminal 1 of the fourth example displays the plural icons related to remote control on the vehicle 5, as the operation unit 12, on the screen of the display unit 11, so as to overlap the synthetic image CP1.

Further, the display unit 11 of the mobile terminal 1 displays the auxiliary image AP2 below the synthetic image CP2. However, on the display unit 11, the arrangement of the synthetic image CP1 and the auxiliary image AP2 in the vertical direction may be changed. The display unit 11 displays, for example, an image acquired by imaging the area above the vehicle 5 during parking of the vehicle 5 into a parking space Psi based on remote control, as an auxiliary image AP2. In the parking space Psi taken as an example, for example, a structure St2 exists on the upper side in the vehicle parking space. In the auxiliary image AP2, an image of the structure St2 is included.

As described above, the display unit 11 of the mobile terminal 1 of the present example displays auxiliary images AP2 which are images acquired by imaging the area above the vehicle 5. According to this configuration, it is possible to check the condition related to contact between the vehicle 5 and other objects above the vehicle 5, on the display unit 11 of the mobile terminal 1. Specifically, for example, in the case where the structure St2 is on the upper side in the parking space of the vehicle 5, it is possible to check whether the vehicle 5 and the structure St2 will come into contact, on the display unit 11 of the mobile terminal 1. Therefore, it is possible to further improve convenience and operability in remote control on the vehicle 5.

### FIFTH EXAMPLE

### 5-5. Fifth Example

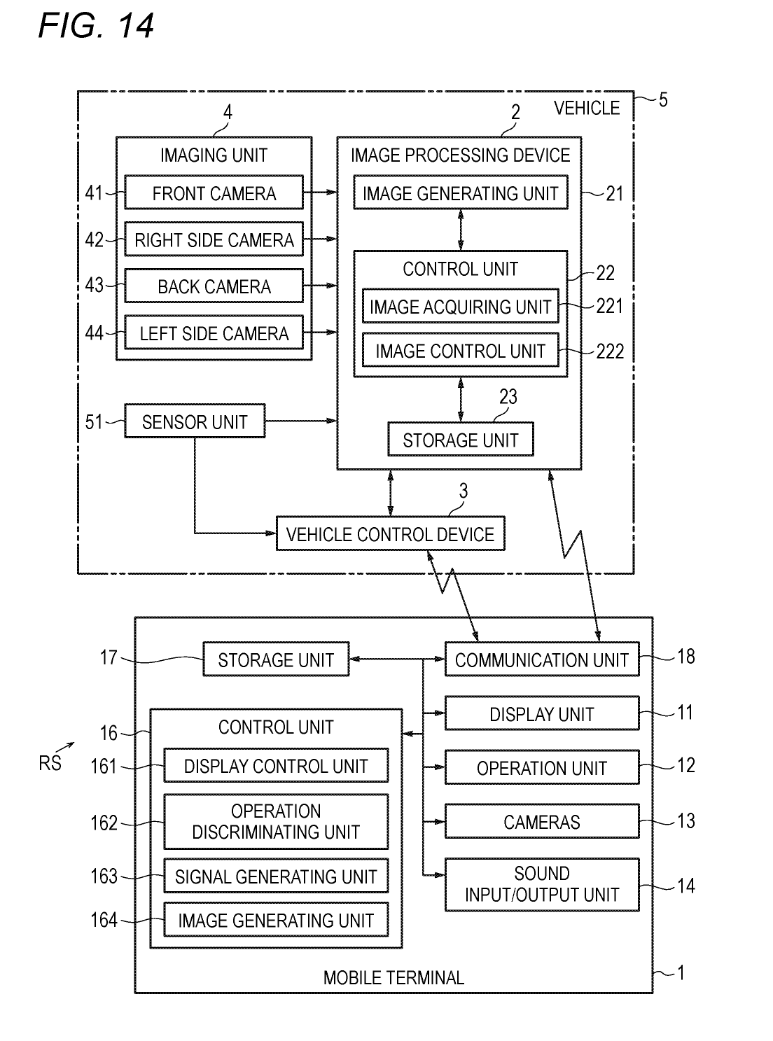

FIG. 14 is a block diagram illustrating the configuration of a remote vehicle control system RS of a fifth example. The mobile terminal 1 of the fifth example has an image generating unit 164, for example, in the control unit 16. The image generating unit 164 generates synthetic images showing the surrounding area of the vehicle 5 by processing images acquired by the imaging unit 4 of the vehicle 5. In the present example, the image generating unit 164 implements a variety of image processing in a software wise, for example, according to a program stored in the storage unit 17.

The mobile terminal 1 receives a variety of data necessary for image processing of the image generating unit 164, from the vehicle 5 via the communication unit 18. As the data necessary for image processing, for example, images acquired by the on-board cameras 41 to 44, the installation states (the installation positions and the camera angles) of the on-board cameras 41 to 44, the camera characteristics (the image size and the image scale), data on images 5p and transparent images 5t of the vehicle 5, and so on are included. The data received from the vehicle 5 is stored, for example, in the storage unit 17.

The image generating unit 164 generates synthetic images showing the surrounding area of the vehicle 5 as seen from virtual viewpoints, on the basis of images acquired by the on-board cameras 41 to 44 and received from the vehicle 5. Further, the image generating unit 164 generates images for display to be displayed on the display unit 11, on the basis of the synthetic images. The image generating unit 164 may generate bird's eye view images and in-vehicle perspective images as synthetic images.

When the user performs remote control on the vehicle 5 using the mobile terminal 1, the mobile terminal 1 performs the communication establishment process and the remote control establishment process in cooperation with the vehicle 5, and then receives a variety of data necessary for image processing of the image generating unit 164 from the vehicle 5. Such data is stored, for example, in the storage unit 17. Thereafter, on the basis of inputs based on user's operations on the operation unit 12, the image generating unit 164 sequentially receives images acquired by the on-board cameras 41 to 44, and generates synthetic images.

### 6. Others

Various technical features disclosed in this specification can be modified variously without departing from the spirit of the technical invention besides the embodiment described above. In other words, it should be understood that the embodiments described above are illustrative and non-restrictive in every respect. It should be understood that the scope of the present invention is defined by the terms of the claims, rather than the description above, and is intended to include any modifications within the scope and meaning equivalent to the terms of the claims. Also, some of the embodiment, the examples, and the modifications described above may be appropriately combined in an acceptable range.

Also, in the above-described embodiment, various functions are implemented in a software wise by computing of the CPUs according to the programs; however, at least some of those functions may be implemented by electrical hardware circuits. Also, conversely, some of functions which are implemented by hardware circuits may be implemented in a software wise.

What is claimed is:

1. A remote vehicle control device comprising:
a display unit;
an operation unit configured for operating a vehicle;
a signal generating unit configured to generate control signals for the vehicle on the basis of operations on the operation unit; and
a communication unit configured to perform communication with the vehicle,
wherein the display unit displays synthetic images, each of which shows a surrounding area of the vehicle as seen from a virtual viewpoint, and includes the surrounding area of the remote vehicle control device, and is generated on the basis of a plurality of images acquired by a plurality of on-board cameras mounted on the vehicle, respectively, and
the communication unit transmits the control signals to the vehicle.

2. The remote vehicle control device according to claim 1, wherein:
the communication unit receives the synthetic images generated in the vehicle, from the vehicle.

3. The remote vehicle control device according to claim 1, wherein:
the control signals include signals related to control on viewpoint positions and sight line directions of the synthetic images.

4. The remote vehicle control device according to claim 1, wherein:
the display unit displays a location of the remote vehicle control device on the synthetic images.

5. The remote vehicle control device according to claim 1, wherein:
when approach of any other object to the vehicle or the remote vehicle control device is detected, the display unit displays expanded synthetic images showing the surrounding area of the object approaching the vehicle or the remote vehicle control device.

6. The remote vehicle control device according to claim 5, wherein:
approach of the object to the vehicle or the remote vehicle control device is determined when the object enters into a predetermined range from the vehicle or the remote vehicle control device.

7. The remote vehicle control device according to claim 5, wherein:
approach of the object to the vehicle or the remote vehicle control device is determined on the basis of the distance from the vehicle or the remote vehicle control device to the object and the movement velocity of the object.

8. The remote vehicle control device according to claim 1, wherein:
the communication unit receives information detected in the vehicle and related to approach of the object to the vehicle or the remote vehicle control device, from the vehicle.

9. The remote vehicle control device according to claim 1, wherein:
the communication unit receives information related to a tilted state of the vehicle, from the vehicle, and
the display unit displays the information related to the tilted state.

10. The remote vehicle control device according to claim 1, wherein:
the communication unit receives information related to a steering angle of the vehicle, from the vehicle, and
the display unit displays the information related to the steering angle.

11. The remote vehicle control device according to claim 1, wherein:
the display unit displays images acquired by imaging an area above the vehicle.

12. A remote vehicle control method comprising:
generating each of synthetic images showing a surrounding area of a vehicle as seen from a virtual viewpoint and including the surrounding area of the remote vehicle control device, on the basis of a plurality of images acquired by a plurality of on-board cameras mounted on the vehicle, respectively;
displaying the synthetic images on a remote vehicle control device;
receiving operations for the vehicle on the remote vehicle control device;
generating control signals for the vehicle, on the basis of the operations; and
transmitting the control signals from the remote vehicle control device to the vehicle.
